(19) United States
(12) Patent Application Publication
(10) Pub. No.: US 2006/0048417 A1
(43) Pub. Date: Mar. 9, 2006

(54) Article with a labeled lateral surface and device for labeling an article

(76) Inventor: Dieter Leykamm, Neutraubling (DE)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/207,397

(22) Filed: Aug. 18, 2005

(30) Foreign Application Priority Data
Sep. 8, 2004 (DE) 102004013947.2

(51) Int. Cl. B65B 53/00; B65D 71/08; G09F 3/00

(52) U.S. Cl. 40/310; 156/510

(57) ABSTRACT

Article having a labeled lateral surface, the article presenting an upper and a lower cylindrical or convex lateral section, and at least one intermediate area shaped radially inward and covered by a shrink label, where the label presents air outlet openings associated with the area that is shaped inwardly. The air outlet openings ensure improved removal of air enclosed under the label, while the shrink wrap label material is gradually applied during shrink treatment to contour the article surface.

### REFERENCE TO RELATED APPLICATION

This disclosure claims priority to German application no. 102004013947.2, filed Sep. 8, 2004.

### FIELD OF THE DISCLOSURE

The innovation concerns an article with a labeled lateral surface and a device for labeling such an article.

### BACKGROUND OF THE DISCLOSURE

An article according to the preamble is known from WO 95/01912. The article disclosed therein is a container with an upper and a lower cylindrical lateral surface and a concavely formed circumferential groove in between. The upper cylindrical area of the lateral surface is followed by a conically narrowing lateral section, which, together with the cylindrical lateral surfaces and the groove is covered by a heat shrinking circumferential label with overlapping end sections. For the labeling, a rectangular label cutout, which is separated, for example, from a label roll, is glued by the area of its label front edge to the cylindrical lateral sections, wound with formation of an overlapping connection between the label edges completely around the container, and applied by a shrinking treatment to the described vessel contour. The problem here is particularly the shrink treatment in the area of the groove zone which is radially shaped inward.

### SUMMARY OF THE DISCLOSURE

In contrast, the innovation is based on the problem of providing an improvement for the labeling of articles with an area that is shaped inward within a lateral surface.

By providing air outlet openings in the section of the label which covers the area of the article, which is radially shaped inward, one ensures an improved removal of the air which is enclosed between the label and the area of the lateral surface, which is shaped radially inward, because the air volume which is enclosed between the label and the mentioned area of the article surface can escape radially outward through the air outlet openings, without any problem, while the shrink label material is gradually applied during the shrink treatment to the contour of the article surface. As a result of the innovative measure, the production of air bubbles under the label is effectively prevented.

To avoid a negative effect on the visual appearance of the label, the air outlet openings can be provided in the label in the form of a perforation which is barely perceivable by the naked eye. In the case of a groove, for example, a concave groove, which is shaped radially inward and covers the entire circumference of an article, it is also particularly advantageous for the perforation line to extend approximately over the entire circumference of the label, to ensure the even removal of air during the shrink treatment. It is preferred for the perforation line to be arranged in the middle of the groove.

Because, after the shrink treatment of the label, a positive locking connection between the label and the article is provided, at least in the axial direction, the adhesive connection to the label starting edge or to the label front edge can be temporary in nature, in order to maintain an adhesive connection only while the label is wound onto the article, where the adhesive connection is then no longer needed after the completion of the overlap connection between the label starting edge and the label terminal edge, which overlaps with the former. With this optional measure, the removal of the label in connection with a later recycling process is also facilitated.

However, the overlapping connection between the label starting edge and the label terminal edge, which overlaps with the former, on the other hand, must be of a lasting quality, to withstand the shrink treatment which occurs after the application by winding, and which is, as a rule, triggered by heating.

For this purpose, a hot glue which hardens under ultraviolet radiation is particularly advantageous. The latter glue can optionally be also used for the adhesion of the label starting edge to the article, particularly if an application of the label is desired which resists twisting and is permanent after the shrink treatment. This type of attachment with a hot glue which hardens under UV exposure on the label starting edge and/or the label terminal edge is also advantageous in the case of a circumferential labeling of articles without an area which is shaped radially inward, that is concave, for example, in the case of bottles, cups or similar devices with cylindrical and/or convex surface sections (see U.S. Pat. No. 4,923,557 or EP 0 675 806 B1). Depending on the material (glass, metal, plastic, cardboard), these objects can be rigid or yielding during the labeling.

### BRIEF DESCRIPTION OF THE DRAWINGS

The preferred embodiment example is explained below with reference to the figures. In the drawing:

FIG. 1 shows an article with an area which is shaped radially inward in a lateral surface which is covered by a label, before and after the labeling, and

FIG. 2 shows a device for labeling an article according to FIG. 1 in a schematic representation.

### DETAILED DESCRIPTION OF THE DRAWINGS

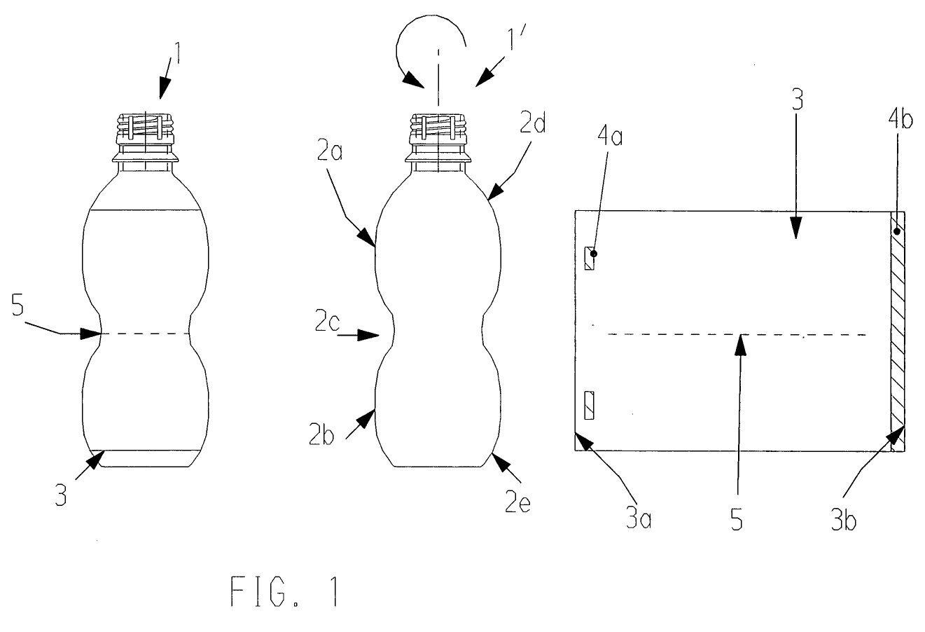

In the embodiment examples shown in FIG. 1, the article to be labeled is a bottle made of plastic, glass or metal, which is intended, for example, for filling with beverages, foods or similar products. In FIG. 1, a bottle 1, which has been completely labeled with a circumferential label, is shown on the left side, while the bottle 1 shown in the middle of the figure presents the contour of the same bottle 1′ in the state without label. On the right side, a rectangular label cutout 3 is provided, which is preferably prepared by separation from a label band.

The lateral surface of the bottle 1′ has an upper lateral section 2a, which is followed, in the direction to the mouth of the bottle, by a narrowing shoulder section 2d. Furthermore, the lateral surface has a lower lateral section 2b, which is followed, in the direction to the bottom of the bottle, by a narrowing lateral section 2e. The lateral sections 2a and 2b can be cylindrical, that is they can extend longitudinally with respect to the bottle axis, or they can be an area with a round, convex surface having a maximum diameter.

Between the upper lateral section 2a and the lower lateral section 2b, an area 2c, which is shaped radially inward, is located, which, in the represented embodiment example, extends over the entire circumference of the bottle 1′ and is concave in design. The bottle 1′ also presents an external contour which is rotation-symmetrical with respect to the longitudinal axis of the bottle.

The circumferential label 3, which is made from a shrink material, possesses a length which extends from the label front edge 3a to the label back edge 3b, and which is greater than the maximum bottle circumference in the area of the upper and lower mantle section 2a and 2b, respectively, so that the label back edge 3b, after the complete application by winding of the label 3 onto the bottle 1′, overlaps with the label front edge 3a in the circumferential direction.

To be able to connect the label front edge 3a and the overlapping label back edge 3b permanently to each other, an adhesive zone 4b is located in the area of the label back edge 3b, preferably extending over the entire label height, and possibly designed, as an example, in the form of a continuous hot glue strip. It is preferred to use hot glue which hardens under UV irradiation.

To apply the circumferential label 3 by winding onto the bottle 1′, adhesive zones 4a are located close to the label front edge 3a, and they are preferably associated exclusively with the upper and the lower lateral section 2a, 2b of the bottle with respect to the height on the label. For this case as well, a UV hardenable hot glue can be used.

The circumferential shrink label 3 presents air outlet openings 5, which, with respect to the height, are arranged approximately in the middle of the area 2c of the bottle 1′, which is shaped radially inward, and which are, for example, in the form of a perforation line which runs parallel to the longitudinal margins of the label. These air outlet openings can be in the form of small holes or longitudinal slits in the label material, which are barely perceptible by the naked eye from the outside.

By approaching the label front edge 3a tangentially to the upper and the lower cylindrical lateral section 2a and 2b, respectively, the circumferential label 3 with the adhesive zones 4a is attached at least temporarily and it is applied completely by winding during the subsequent rotation of the bottle 1′ about its high axis until the front and the back label edges overlap. After this process of application by winding, the circumferential label 3 covers not only the area 2c, which is shaped inward, but also parts of the lateral areas 2d and 2e.

By exposing the adhesive zone 4b in the overlapping area to UV radiation, if a hardenable hot glue is used, the permanent crosslinking of the glue occurs, even before they shrink treatment of the label 3 for matching the bottle contour is started.

If the labels are made of a thermoplastic film material, the shrink process is carried out by means of a heat treatment, for example, by exposure to hot air, steam or infrared radiation. In the process, the label material shrinks in the radial direction toward the bottle's lateral surface, where the air which is enclosed in the radially retracted area 2c between the lateral surface of the bottle and the back side of the circumferential label 3 can escape through the above-mentioned air outlet openings 5, so that a bubble-free application of the label material against the bottle contour is ensured.

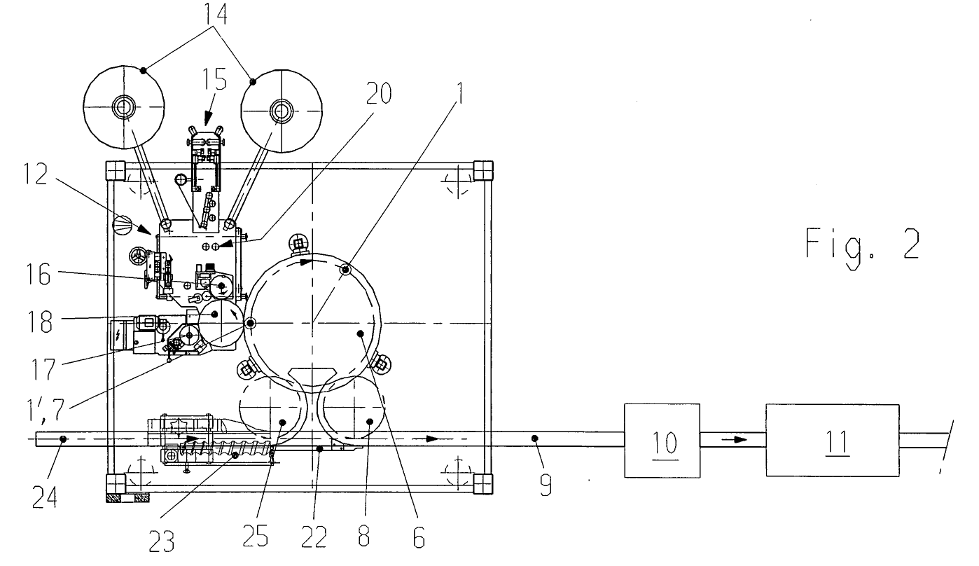

FIG. 2 shows a labeling machine in a schematic top view, which is suitable for the above-described labeling, and which allows a continuous, high output, application of circumferential labels 3 onto bottles 1′, which are advanced continuously in a one-track row.

It has a supply conveyor 24, an inlet star wheel 25 preceded by a single-part worm 23, a guide arc 22, a carousel 6 with a multitude of rotating plates 7, which are arranged at even intervals on a common partial circle, a delivery star wheel 8 and a delivery conveyor 9, which passes through a UV tunnel 10 and a shrink tunnel 11. The mentioned transport elements, which move the bottles through the machine, can be driven in such a manner that their speeds and positions are synchronous with respect to each other.

In the circumferential area between the inlet star wheel 25 and the delivery star wheel 8, on the external peripheral of the carousel 6, a labeling unit 12 is located for the application of circumferential labels 3 made of heat shrinking plastic film. The labeling unit 12 has two label roll recesses 14, with a splicing station 15, a cutting tool 16, a glue application station 17 and a vacuum cylinder 18 located in between, for transferring a label 3, which has been precut and coated with glue on its front and back edge, onto a passing bottle 1′. If a label film band is processed, which has not already been provided with air outlet openings 5, the labeling unit is provided with a perforation device 20, which is arranged, seen in the direction of advance of the band between the splicing station 15 and the cutting tool 16, and which consists, for example, of a needle-fitted perforation roller and a counter roller.

The details of the operation of the labeling process of a bottle 1′ are as follows:

A bottle 1′, which is supplied by a supply conveyor 24, is introduced, in connection with the laterally arranged one-part worm 23, in the correct position into the inlet star wheel 5 and it is transferred by the latter by shifting, in collaboration with the opposite guidance arc 22, in a continuous motion, to a rotating plate 7 of the rotating carousel 6. There the bottle 1′ is clamped, in a manner which allows rotation, by a centering bell, which is not shown, and which can be lifted and lowered in a controlled manner with respect to the rotating plate 7, axially onto the rotating plate, with which it turns, and then it is approached tangentially to the vacuum cylinder 18 of the labeling unit 12, as a result of the circumferential movement of the carousel.

Simultaneously, one of the two label band rolls leads the plastic film band to a controlled band pull off device in collaboration with a printed design or marking recognizing sensor [and] to the cutting tool 16, so that a rectangular label, which is cut out to a length (with excess) which corresponds to the cylindrical lateral circumference of the bottle 1′, is transferred separated, in the correct position with respect to the printed design, onto the vacuum cylinder 18, which then passes the circumferential label 3, with its back side turned outward, past the glue roller of the gluing station 17. In the process, the circumferential label 3, in the area of its preceding and following edges 3a and 3b, respectively, receives the application of a glue consisting of a UV hardenable hot glue, which is preferably applied in the shape shown in FIG. 1.

The label front edge 3a is then brought in contact with the lateral surfaces 2a and 2b of the bottle 1′, with the associated adhesive zones 4a glued on, and, during the subsequent process, it is applied by winding over the entire circumference as a result of the rotation of the bottle 1′, which is caused by the rotating plate 7, where the label back edge 3b, after completion of the rotation, overlaps with the label front edge 3a and becomes attached with the adhesive zone 4b to its external side. The described process occurs during a continuous advance movement of the carousel 6.

After the passage of the labeling unit 12 and after the completion of the process of application by winding, the labeled bottle 1, during the continuation of the process, reaches the delivery star wheel 8 and it is transferred to the delivery conveyor 9.

The delivery conveyor 9 transports the bottle 1 first through the UV tunnel 10, which, as a result of the UV irradiation, produces an intensive crosslinking and hardening of the hot glue, even before the thermal application of the shrink plastic label in the shrink tunnel 11 starts. Because of the mentioned UV treatment, the hot glue is exposed to heat. The bursting of the overlapping adhesion during the shrink treatment is thus reliably prevented. The shrink treatment can be designed in such a manner that the upper and lower label margin is exposed to heat before the middle label area. For example, it is conceivable to provide optionally for a local heat shrinking treatment with appropriately positioned blow nozzles or heat radiators, so that the label areas which are already applied against the lateral surface when the label is applied by winding no longer have to be shrunk.

Naturally, the described innovation can also be applied to articles having several areas which are shaped radially inward in the lateral surface.

I claim:

1. Article (1) with a labeled lateral surface, comprising an upper and a lower cylindrical and/or convex lateral section (2a, 2b), at least one intermediate area (2c), which is shaped radially inward and covered by a shrink label (3), the label (3) and presenting at least air outlet openings (5) which are associated with the area (2c) which is shaped radially inward.

2. Article according to claim 1, wherein the air outlet openings (5) are designed as a perforation in the label material.

3. Article according to claim 1, wherein the area (c) of the lateral surface, which is shaped radially inward, is designed so it runs over the entire circumference.

4. Article according to claim wherein the air outlet openings (5) are designed in the form of at least one perforation line which covers the entire circumference.

5. Article according to claim 1, wherein the label (3) is a circumferential label with overlapping starting and terminal edges (3a, 3b).

6. Article according to claim 5, wherein the label (3), in the area of its starting edge (3a), is connected with an adhesive (4a), at least temporarily to the lateral surface (2a, 2b) of the article.

7. Article according to claim 5 wherein the label (3), at least in the area of its overlapping terminal edge (3b), is permanently connected to the starting edge (3a).

8. Article according to claim 1, wherein the lateral surface, at least above and/or below the area (2c), which is shaped radially inward, presents a narrowing area (2d, 2e), which is at least covered by the label (3).

9. Article (1) having a lateral surface which is labeled with a heat shrinking circumferential label (3), comprising a label (3) which, close to its starting edge and/or terminal edge (3b), presents an area of UV hardenable hot glue (4b, 4a), where the label length is preferably measured in such a manner that the terminal edge overlaps with and is connected with the starting edge.

10. Device for labelling an article according to claim 1, wherein the device presents means (20) for the perforation of air outlet openings (5) in a label (3).

11. Device according to claim 10, wherein the means comprise a perforation tool (20), which is arranged in the conveyance path of the labels (3).

12. Device for labelling an article according to claim 1, and having at least one gluing station (17) for the formation of adhesive zones (4a, 4b) with UV hardenable hot glue close to the label starting edge and/or label terminal edge of a label (3), and a device (10) for the exposure of an article to UV radiation after a label has been applied.

13. Device according to claim 12, and comprising a vacuum cylinder (18), which can be driven in rotation, on whose periphery the gluing station (17) is arranged, and which moves the labels (3) past the gluing station for the formation of the adhesive areas (4a, 4b).

14. Article according to claim 6, wherein the adhesive (4a) is hot glue.

15. Article according to claim 7, wherein the permanent connection is by means of a UV hardenable hot glue (4b).

16. Device according to claim 11, wherein the perforation tool (20) is arranged in the conveyance path of the labels (3) at the height of the areas (2c) of the lateral surface of the section of the label which is associated with the article, which area is shaped radially inward.
